(19) United States
(12) Patent Application Publication
(10) Pub. No.: US 2013/0300211 A1
(43) Pub. Date: Nov. 14, 2013

(54) INDUCTIVE CONTACTLESS ENERGY AND DATA TRANSMISSION SYSTEM

(71) Applicants: Faical Turki, Berkamen (DE); Benedikt Schmulling, Herne (DE)

(72) Inventors: Faical Turki, Berkamen (DE); Benedikt Schmulling, Herne (DE)

(73) Assignee: Paul Vahle Gmbh & Co., KG, Kamen (DE)

(21) Appl. No.: 13/976,201

(22) PCT Filed: Mar. 28, 2012
(86) PCT No.: PCT/EP2012/055515

§ 371 Date: Jun. 26, 2013

(30) Foreign Application Priority Data
May 27, 2011 (DE) 10 2011 103 318.5

(51) Int. Cl. H04B 5/00

(52) U.S. Cl. CPC H04B 5/0037
USPC 307/104

(57) ABSTRACT

The invention relates to an inductive contactless energy and data transmission system (1) having a primary-side coil arrangement and a secondary-side coil arrangement, the primary-side coil arrangement and secondary-side coil arrangement each having at least one coil (3, 7) for energy transmission and at least one coil (4, 6) for data transmission, characterised in that the primary-side and secondary-side coils for energy transmission are in the form of coils (3, 7) which each have a single winding direction, and in that the coils (4, 6) for data transmission are coil arrangements which each have at least two coil fields (4a, 4b, 4c, 4d).

The present invention relates to an inductive contactless energy and data transmission system having a primary-side coil arrangement and a secondary-side coil arrangement, the primary-side coil arrangement and secondary-side coil arrangement each having at least one coil for energy transmission and at least one coil for data transmission.

U.S. 2010/0201315 discloses a system in which a primary coil and a plurality of secondary coils are used. The secondary-side coils are arranged spaced apart from each other. The magnetic field of the primary coil induces, depending on the positioning of the secondary coils, voltages of different sizes therein. By evaluating the voltages, the position of the secondary coils relative to the primary coil can be evaluated.

An object of the present invention is to provide an inductive contactless energy and data transmission system in which the data transmission is not influenced by the energy transmission.

This object is achieved according to the invention with a system having the features of claim 1. Advantageous embodiments of the system according to claim 1 will be appreciated from the features of the dependent claims.

The system according to the invention is a development of already-existing systems for inductive contactless energy transmission, which each have a primary and a secondary coil for energy transmission. In the system according to the invention, additional primary-side and secondary-side coil arrangements for data transmission are arranged. They are arranged in the region of the energy transmission coils. They can thus be arranged together with the energy transmission coil in a housing or in a casting compound.

The data transmission may become exhausted during the transmission of simple signals, such as, for example, an input, output signal. However, it is also possible to transmit more complex signals. It is also possible to transmit data in a bidirectional manner.

Reference to the secondary side is also intended to include reference to a pickup which is generally arranged on freely movable vehicles or on track-bound vehicles and current collectors. With such a system, the coil arrangements are preferably constructed as flat coils so that the best possible coupling factor is achieved.

The primary-side and secondary-side coil arrangements may in the most simple case be constructed in an identical manner.

The invention is based on the notion that an influence of the data transmission by the magnetic field of the energy transmission is advantageously prevented when the data transmission coils have a plurality of coil fields and that the voltages which are induced by the field of the energy transmission in the coil fields of the data transmission coils compensate for each other. The coils which form the coil fields may be single coils which are connected with respect to each other in series and/or in parallel. It should simply be ensured in this instance that the coils are connected to each other in such a manner that the induced voltages compensate for each other. Coils with a different winding direction can also be used.

It is also possible to construct or wind all coil fields by means of a continuous conductor, in which case it should then be ensured that a first number of coil fields having a first winding direction and the same number of coil fields with the opposing winding direction are provided.

When a continuous conductor is used to form the data transmission coil arrangement, this affords the advantage that no coils have to be connected together and that the coil arrangement has only two connection lines.

The individual coil fields may also be formed by coils with mutually different numbers of windings and/or coil cross-section surface-areas. However, in the most simple case, the coil cross-sections and numbers of windings of the coils which form the coil fields are intended to be constructed so as to be identical.

A preferred arrangement is distinguished in that the coils for energy transmission are coils with a single winding direction, and in that the coils for data transmission are coils which have a number of 2 times N coil fields, N being a whole number greater than or equal to one and N coil fields having a first winding direction and N coil fields having an opposing winding direction, the primary-side and secondary-side data transmission coils being constructed so as to be mutually identical at least with regard to the arrangement of the coil fields. Such a coil arrangement may advantageously be formed or wound by means of a continuous conductor.

The construction and arrangement of the primary-side and secondary-side data transmission coil arrangements, in particular on the charging plate and the pickup, are advantageously the same or similar in order to achieve the best possible coupling and to ensure a good signal quality.

Advantageously, the primary-side and secondary-side coils for energy transmission each have only a single winding direction. The energy transmission coils are intended to be constructed as flat coils for better coupling. However, they can, of course, also be constructed as a cylindrical coil.

In the inductive and contactless energy and data transmission system according to the invention, the primary-side and secondary-side coil arrangements are positioned precisely in a correct manner relative to each other when the primary-side or secondary-side energy transmission coil produces a magnetic flux which extends through all coil fields of the primary-side and/or secondary-side data transmission coils at the same time in the same direction. With the correct positioning, on the one hand, the best coupling factor is achieved for the energy transmission, with, at the same time, the data transmission not being influenced by the energy transmission. Consequently, at the same time, in addition to the energy transmission by means of the energy transmission coils, data can also be transmitted via the data transmission coil arrangements without the occurrence of disruptive influences.

The system according to the invention may be constructed in such a manner that the primary-side and secondary-side coil arrangements for energy transmission are smaller, of the same size or greater than the coil arrangements for data transmission. Thus, it is advantageous for the coil arrangements for data transmission to completely cover the coil arrangements for energy transmission. With such an arrangement, the coil arrangement for data transmission can also further be used for relative positioning of the primary side and secondary side. It is thus possible for the primary side to be able to be adjusted by means of a drive in such a manner that, for example, the primary-side coil arrangement, comprising an energy transmission coil and data transmission coil arrangement, is moved relative to a vehicle which carries the pickup and which is, for example, in a garage until an optimal coupling is produced. A data processing device, using the voltages or voltage induced in the individual coil fields or the coil arrangement, can also position a vehicle or generate corresponding directional indications for the correct positioning. The direction display may be carried out in an acoustic and/or visual manner. The display may, for example, be arranged in the vehicle itself or the garage.

The secondary-side coil arrangements for energy transmission and data transmission may be cast or arranged one above the other, in particular together in a housing or together in a mass. The same applies to the primary-side coils for data and energy transmission.

In order to keep the influence of parasitic capacitances, in particular conductor/earth capacitances, low, the primary-side coil arrangement for the data transmission is advantageously galvanically separated from the supply network by a transformer.

The invention is explained in greater detail below with reference to various embodiments and drawings, in which:

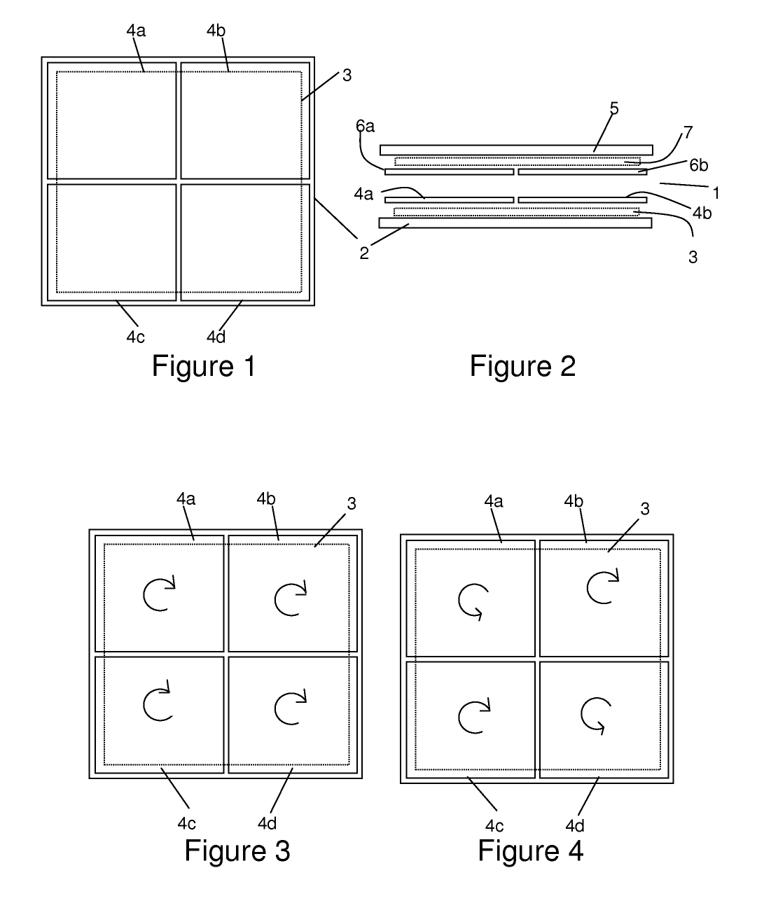

FIG. 1: is a plan view of the primary-side coil arrangement comprising an energy transmission coil and a data transmission coil arrangement with four coil fields;

FIG. 2: is a side view of an energy transmission system according to the invention comprising the primary-side and secondary-side coil arrangement;

FIG. 3: shows a primary-side coil arrangement for data transmission having four coil fields with the same winding direction;

FIG. 4: shows a primary-side coil arrangement for data transmission with four coil fields having a different winding direction;

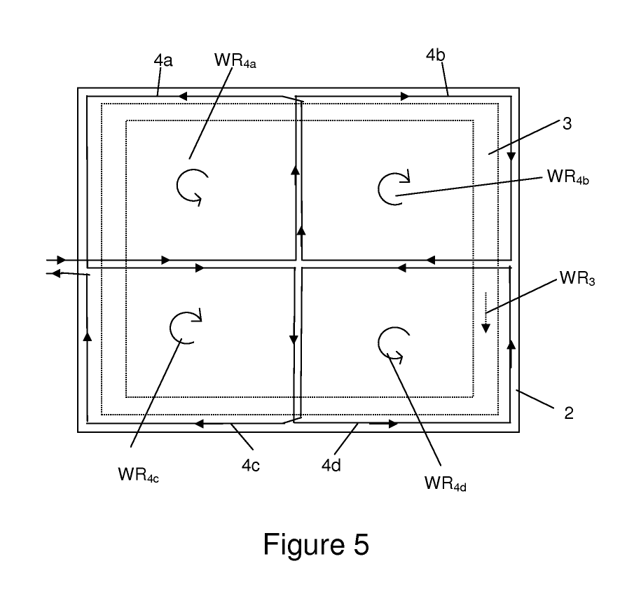

FIG. 5: shows a coil arrangement for data transmission having four coil fields with a different winding direction, coils being wound by means of a continuous conductor.

FIG. 1 is a plan view of the primary-side coil arrangement comprising an energy transmission coil 3 and a data transmission coil arrangement 4 having four coil fields 4a to 4d. The energy transmission coil 3 and the data transmission coil arrangement 4 are arranged on the carrier 2. They may also be surrounded by means of a casting compound which is not illustrated. The secondary-side coil arrangement may be constructed in an identical or very similar manner.

FIG. 2 is a side view of an energy transmission system 1 according to the invention comprising the primary-side and secondary-side coil arrangement, comprising the energy transmission coil 3, 7 and the data transmission coil arrangements 4, 6. The energy transmission coil 3, 7 is slightly smaller in terms of the dimensions thereof so that the data transmission coil arrangements 4, 6 laterally overhang them when the primary-side and secondary-side coil arrangements are positioned correctly relative to each other.

As illustrated in FIGS. 3 and 4, the coil arrangement for the data transmission may be constructed with four coil fields 4a to 4d either with the same winding direction (FIG. 3) or with a different winding direction (FIG. 4). With the relative positioning of the primary-side and secondary-side coil arrangements illustrated in FIG. 2, it must always be ensured that the resultant voltage induced by the magnetic field of the energy transmission coil in the coil arrangements 4a to 4d is zero. The coils which form the individual coil fields 4a to 4d in the arrangements illustrated in FIGS. 3 and 4 may be connected in series and/or parallel with respect to each other. However, it should always be ensured that the resultant voltage induced by the magnetic field of the energy transmission coil is zero at the terminals of the data transmission coil arrangement. The coils which form the coil fields must be interconnected at the primary side and at the secondary side in an identical manner so that a resultant voltage can be induced by the magnetic field of one coil arrangement 4 or 7 in the other coil arrangement 7 or 4 and a data transmission is consequently possible, respectively.

FIG. 5 shows a coil arrangement for data transmission having four coil fields 4a to 4d with a different winding direction WS, the coils which form the coil fields 4a to 4d being formed by individual windings by means of a continuous conductor. The arrows indicate the direction of the electrical current at a specific time. The flow which is linked to the mutually adjacent windings and which is produced by the coil itself flows in opposing directions so that the flow over the entire face of the data transmission coil is zero.

The magnetic flux produced by the energy transmission coil 3 located below the data transmission coils 4 brings about in the individual windings of the data transmission coil 4 an induced voltage with the same value. However, the prefixes of this induced voltage are alternately positive and negative in the mutually adjacent coils so that the overall total of the induced voltage is zero.

Of course, it is possible for the windings which form the coil fields 4a to 4d to have another shape and, for example, to have rounded corners or to be constructed so as to be circular. It is also possible for the individual coil fields 4a to 4d to have different sizes and/or numbers of windings.

1. An inductive contactless energy and data transmission system, including:
a primary-side coil arrangement and
a secondary-side coil arrangement,
wherein the primary-side coil arrangement and the secondary-side coil arrangement each include at least one coil for energy transmission and at least one coil for data transmission,
wherein the primary-side and secondary-side coils for energy transmission are in the form of coils that each have a single winding direction, and
wherein the coils for data transmission are coil arrangements that each have at least two coil fields.

2. The inductive contactless energy and data transmission system according to claim 1, wherein voltages that are induced in the individual coil fields of the coil arrangements by magnetic field of the energy transmission coils compensate for each other to a neutral state as long as the primary-side and secondary-side coil arrangements are positioned relative to each other in such a manner that the magnetic field of the energy transmission coil passes through all the coil fields to the same extent.

3. The inductive contactless energy and data transmission system according to claim 1, wherein at least one coil field is formed by a coil having a first winding direction and at least one coil field is formed by a coil having an opposing winding direction.

4. The inductive contactless energy and data transmission system according to claim 1, wherein the coils for data transmission are coils which have a number of 2 times n coil fields, n being a whole number greater than or equal to one, with n coil fields having a first winding direction and n coil fields having an opposing winding direction, the primary-side and secondary-side data transmission coils being constructed so as to be mutually identical at least with regard to the arrangement of the coil fields.

5. The inductive contactless energy and data transmission system according to claim 1, wherein each coil field of the data transmission coils has at least one winding.

6. The inductive contactless energy and data transmission system according to claim 1, wherein the data transmission coils are formed by means of a continuous conductor or by means of individual coils which are connected to each other, which are connected in parallel or in series, and which each form at least one coil field.

7. The inductive contactless energy and data transmission system according to claim 1, wherein the coil fields of the data transmission coils are formed by means of coils with different winding numbers and/or coil cross-section surface-areas.

8. The inductive contactless energy and data transmission system according to claim 1, wherein the primary-side or secondary-side energy transmission coil is configured to produce a magnetic flux which extends through all the coil fields of the primary-side and/or secondary-side data transmission coils at the same time in the same direction, as long as the secondary-side coil arrangements are positioned correctly with respect to the primary-side coil arrangements.

9. The inductive contactless energy and data transmission system according to claim 1, wherein the coil arrangement for energy transmission in the coil arrangement for data transmission induces no electrical voltage as long as the secondary-side coil arrangements are positioned correctly with respect to the primary-side coil arrangements.

10. The inductive contactless energy and data transmission system according to claim 1, wherein the primary-side and secondary-side coil arrangements for energy transmission and for data transmission each have two connection lines.

11. The inductive contactless energy and data transmission system according to claim 1, wherein the primary-side and secondary-side coil arrangements for energy transmission are smaller, the same as or larger in size than the coil arrangements for data transmission in such a manner that the coil arrangements for energy transmission completely cover the coil arrangements for data transmission or the coil arrangements for data transmission completely cover the coil arrangements for energy transmission.

12. The inductive contactless energy and data transmission system according to claim 1, wherein the primary-side and secondary-side coil arrangements for energy transmission are each formed by a cylindrical flat coil or a cylindrical coil each having a plurality of windings.

13. The inductive contactless energy and data transmission system according to claim 1, wherein the primary-side coil arrangements for energy transmission and data transmission are arranged one above the other, cast together in a housing or cast together in a mass.

14. The inductive contactless energy and data transmission system according to claim 1, wherein the secondary-side coil arrangements for energy transmission and data transmission are arranged one above the other, cast together in a housing or cast together in a mass.

15. The inductive contactless energy and data transmission system according to claim 1, wherein the system is configured to evaluate voltage induced in the coil arrangements for data transmission by means of a data processing device and to acoustically and/or visually display how the primary-side and secondary-side coil arrangements are currently arranged relative to each other and/or in which direction the secondary-side and/or primary-side coil arrangements are intended to be moved so that the primary-side and secondary-side coil arrangements are correctly positioned relative to each other, with the best coupling factor.

16. The inductive contactless energy and data transmission system according to claim 15, wherein the acoustic and/or visual display is carried out in a vehicle or in a stationary manner in a room by means of a display device and/or a loudspeaker.

17. The inductive contactless energy and data transmission system according to claim 1, wherein the at least one primary-side data transmission coil is galvanically separated from a supply network by means of a transformer.

18. A method for positioning secondary-side coil arrangements relative to primary-side coil arrangements of an inductive contactless energy and data transmission system, the method including:
establishing, by a data processing device, electrical voltage or voltages induced in a coil arrangement for data transmission, in the inductive contactless energy and data transmission system; and
evaluating, by the data processing device, the electrical voltage or voltages to produce position signals or direction signals for positioning the secondary-side coil arrangements relative to the primary-side coil arrangements.

19. The method according to claim 18, wherein either:
a magnetic field is produced by means of the primary-side coil arrangement for data transmission, and a change of the voltage induced in the coil arrangement of the secondary-side data transmission coils resulting from a position change is evaluated in order to establish the relative position of the primary side relative to the secondary side,
or
a magnetic field is produced by means of the secondary-side coil arrangement for data transmission, and a change of the voltage induced in the coil arrangement of the primary-side data transmission coils resulting from a position change is evaluated in order to establish the relative position of the primary side relative to the secondary side.
